(19) United States
(12) Patent Application Publication
(10) Pub. No.: US 2017/0066934 A1
(43) Pub. Date: Mar. 9, 2017

(54) COATINGS FOR INCREASING COLOUR VIBRANCY AND METHODS OF APPLYING SAME

(71) Applicant: Barry R. KNOWLTON, Napanee (CA)

(72) Inventor: Barry R. KNOWLTON, Napanee (CA)

(21) Appl. No.: 14/944,333

(22) Filed: Nov. 18, 2015

Related U.S. Application Data
(60) Provisional application No. 62/213,882, filed on Sep. 3, 2015.

(51) Int. Cl. C09D 7/12; C09D 133/12; C09D 133/08; C09D 133/20

(52) U.S. Cl. CPC C09D 7/1216; C09D 133/20; C09D 133/12; C09D 133/08; C08K 3/36

(57) ABSTRACT

A coating for application to a natural-coloured substrate is provided that allows for increased colour vibrancy of dye applied to the coated substrate. The coating comprises silica particles and at least one binder solid, and in addition, may comprise siloxane. The coating may comprise a mono or a poly aqueous sol dispersion of silica particles optionally having particle sizes from about 1 to about 150 nm.

### CROSS-REFERENCE TO RELATED APPLICATIONS

This application claims priority to U.S. Provisional Application No. 62/213,882, filed on Sep. 3, 2015, now pending, the disclosure of which is incorporated herein by reference.

### FIELD OF THE INVENTION

The present invention relates to coatings for application to substrates that increase the colour vibrancy of dyes applied to the treated substrate and methods for applying the coatings to substrates.

### BACKGROUND

Substrates, such as paperboard products, are commonly treated with coatings before printing thereon, for example, to reduce smearing and rub off of the ink, to enhance the water fastness and colour density of the ink, to provide scratch resistance, to increase substrate gloss, weight, stiffness, smoothness and ink absorption, and to protect against ultraviolet radiation.

Printing on natural-coloured substrates, such as paperboard products, that have not been bleached has recently gained interest, at least in part due to increased environmental awareness. The use of natural-coloured substrates, such as beige, brown or grey coloured paperboards, derived from recycled sources is becoming increasingly popular. However, the ability to print multicolour graphics with pigmented translucent dyes used in lithographic offset printing on natural-coloured substrates has been limited. The final image printed with translucent dyes may have a degree of substrate colour showing through, resulting in a reduction of colour vibrancy compared to images printed on reflective white substrates. Additionally, mottling of the printed image due to variations in substrate colour and porosity common to recycled papers reduces the quality of the image printed with translucent dyes. To reduce such problems, selected recycled waste grades of kraft paper having a uniform light brown colour have been developed. These types of papers provide improved brightness when compared to similar darker brown substrates and these engineered substrates provide a high level of ink holdout at printing, which also improves substrate vibrancy. This process however is limited to higher qualities of recycled paper and printing on darker natural-coloured recycled paper is still largely ineffective.

There is therefore a need for coatings that may be applied to substrates, such as natural-coloured substrates, which may increase the colour vibrancy of a dye printed on the substrate.

### SUMMARY OF THE INVENTION

In one embodiment, the present invention provides for a translucent coating for a substrate, the coating comprising silica particles and one or more binder solids.

In a further embodiment of the translucent coating or coatings outlined above, the silica particles are substantially spherical particles of anionic amorphous silica.

In a further embodiment of the translucent coating or coatings outlined above, the silica particles are in an aqueous sol dispersion.

In a further embodiment of the translucent coating or coatings outlined above, the coating comprises a mono or a poly dispersement of the silica particles.

In a further embodiment of the translucent coating or coatings outlined above, the silica particles in the mono dispersement have an average particle size from about 1 to about 150 nm.

In a further embodiment of the translucent coating or coatings outlined above, the silica particles in the mono dispersement have an average particle size from about 12 to about 40 nm.

In a further embodiment of the translucent coating or coatings outlined above, the silica particles in the mono dispersement have an average particle size from about 16 to 18 nm.

In a further embodiment of the translucent coating or coatings outlined above, the coating comprising the poly dispersement further comprises siloxane.

In a further embodiment of the translucent coating or coatings outlined above, the silica particles in the poly dispersement have a particle size of from about 1 to about 150 nm.

In a further embodiment of the translucent coating or coatings outlined above, the coating comprises from about 5 to about 40% w/w of silica particles.

In a further embodiment of the translucent coating or coatings outlined above, the coating comprises from about 15 to about 30% w/w of silica particles.

In a further embodiment of the translucent coating or coatings outlined above, the coating comprises about 25% w/w of silica particles.

In a further embodiment of the translucent coating or coatings outlined above, the coating is for application to the substrate at a density of from about 0.5 to 10 g silica particles per square meter.

In a further embodiment of the translucent coating or coatings outlined above, the coating is for application to the substrate at a density of from about 2.0 to about 3.5 g silica particles per square meter.

In a further embodiment of the translucent coating or coatings outlined above, the coating is applied more than once to the substrate.

In a further embodiment of the translucent coating or coatings outlined above, the silica particles:the at least one binder solids ratio is from about 10:1 to about 80:1 by weight.

In a further embodiment of the translucent coating or coatings outlined above, the silica particles:the at least one binder solids ratio is from about 35:1 to about 50:1 by weight.

In a further embodiment of the translucent coating or coatings outlined above, the silica particles:the at least one binder solids ratio is about 50:1 by weight.

In a further embodiment of the translucent coating or coatings outlined above, the coating is diluted with water.

In a further embodiment of the translucent coating or coatings outlined above, the coating is suitable for application of a pigmented translucent dye thereon.

In a further embodiment of the translucent coating or coatings outlined above, the coating has a translucent and matte finish.

In a further embodiment of the translucent coating or coatings outlined above, the substrate is a paperboard.

In a further embodiment of the translucent coating or coatings outlined above, the substrate has a natural colour.

In a further embodiment of the translucent coating or coatings outlined above, the substrate comprises from about 0 to about 100% recycled content.

In a further embodiment of the translucent coating or coatings outlined above, the substrate has a brightness of from about 5 to about 80.

In another embodiment, the present invention provides for a coating for increasing the colour vibrancy of a dye applied to a substrate comprising:

a sol aqueous dispersion of anionic silica particles having a range of sizes from about 1 to about 150 nm;

at least one binder solids;

siloxane;

wherein the silica particles comprise about 25% w/w of the coating; and

the silica particle:the at least one binder solids ratio is 50:1 by weight.

In yet another embodiment, the present invention provides for a method of increasing the colour vibrancy of a dye applied to a substrate, the method comprising:

a) applying a coating in an amount of from about 0.5 to about 10 g of silica particles per square meter of the substrate; and

b) drying or curing the binder solids.

In yet another embodiment, the present invention provides for a method of increasing the colour vibrancy of a dye applied to a substrate, the method comprising:

a) applying a coating as outlined above and optionally in an amount of from about 0.5 to about 10 or optionally from about 2.0 to about 3.5 g of silica particles per square meter of the substrate; and

b) drying or curing the binder solids.

In a further embodiment of the method or methods outlined above, step b) comprises applying heat to dry or cure the binder solids.

In a further embodiment of the method or methods outlined above, the method further comprises a preliminary step of selecting the substrate based on the repellency of the substrate.

In a further embodiment of the method or methods outlined above, the substrate is pretreated with a repellent coating.

In an even further embodiment, the present invention provides for a substrate comprising a coating applied thereto, wherein the coating is as defined in any of the embodiments outlined above.

### BRIEF DESCRIPTION OF THE DRAWINGS

FIG. 1 is a representation of the CIELAB 3-dimensional colour space showing coordinates L *, a *, b* and C* (chroma).

FIG. 2 is a graph depicting the percent reflectance (y-axis) versus wavelength (x-axis) of printed cyan on a coated natural colour paperboard wherein wavelengths are in nm.

FIG. 3 is a graph depicting the percent reflectance (y-axis) versus wavelength (x-axis) of printed magenta on a coated natural colour paperboard wherein wavelengths are in nm.

FIG. 4 is a graph depicting the percent reflectance (y-axis) versus wavelength (x-axis) of printed yellow on a coated natural colour paperboard wherein wavelengths are in nm.

FIG. 5 is a graph depicting the percent reflectance (y-axis) versus wavelength (x-axis) of printed black on a coated natural colour paperboard wherein wavelengths are in nm.

### DETAILED DESCRIPTION

Described herein are embodiments of coatings for natural-coloured substrates that increase the colour vibrancy of dyes applied to the coated substrate. Also described herein are methods for applying the coatings to substrates. It will be appreciated that the coatings, methods, embodiments and examples described herein are for illustrative purposes intended for those skilled in the art and are not meant to be limiting in any way. All references to embodiments or examples throughout the disclosure should be considered a reference to an illustrative and non-limiting embodiment or an illustrative and non-limiting example.

According to an embodiment of the present invention, there is provided a coating for increasing the colour vibrancy of a dye on a substrate comprising silica (SiO₂) particles and one or more binder solids. In one example, the silica particles are anionic, amorphous, generally spherical silica particles in an aqueous sol dispersion and may comprise counterions such as Na⁺, NH₄⁺, or combinations thereof. The term “aqueous sol dispersion” generally refers to a colloidal suspension of silica particles in any aqueous liquid, for example water, and also including, for example, aqueous solutions also comprising methanol, ethanol, acetone or combinations thereof.

The present invention also provides embodiments for coatings comprising a mono or poly dispersement of silica particles. In the context of the present invention, a mono dispersement encompasses silica of substantially one approximate size, wherein any variation in size falls within a tight range. In one embodiment of the coating comprising a mono dispersement, the size of the silica particles is in the range of about 1 to about 150 nm. For example, in one embodiment a majority of the silica particles have a size of about 1, 10, 20, 30, 40, 50, 60, 70, 80, 90, 100, 110, 120, 130, 140 or 150 nm. In a further embodiment of the coating comprising a mono dispersement, the size of the silica particles is in the range of about 12 to about 40 nm. For example, in one embodiment, a majority of the silica particles have a size of about 12, 16, 20, 24, 28, 32, 36 or 40 nm. In yet a further embodiment of the coating comprising a mono dispersement, the size of the silica particles is in the range of about 16 to about 18 nm. Further, the silica particles may have sizes between any two values listed above.

In the context of the present invention, a poly dispersement comprises silica of various sizes. In one embodiment, a poly dispersement comprises silica of essentially three sizes, wherein any variation within the three sizes falls within a tight range. This may be prepared, for example, by mixing three sizes of silica particles together. In another embodiment, the poly dispersement comprises silica of more than three sizes, for example four, five, six or more different sizes. A range of silica particle size may be attained by adding siloxane to a mono dispersed silica solution to form agglomerates of two, three or more silica particles. It will be appreciated that siloxane may be added in sufficient quantities to partially react some but not all of the silica particles and therefore the amount of single silica particles may be modified. This dispersement of silica particle size allows for a pebbling effect when applied to a substrate and results in a matte finish with the ability to increase colour vibrancy of an image printed thereon. The size of the silica particles in both poly dispersement embodiments outlined above is from about 1 to about 150 nm. For example, in one embodiment, the size of the silica particles may be about 1, 10, 20, 30, 40, 50, 60, 70, 80, 90, 100, 110, 120, 130, 140 and 150 nm and the silica particles may have sizes between any two values listed above.

It will be appreciated that the term “coating” encompasses a coating that has not been applied to a substrate, such as a coating stored in a container or a prepared coating that has not yet been applied to a substrate.

In the context of the present invention, the phrase “increasing the colour vibrancy” generally refers to, without being limiting, increasing the colourfulness, purity, chroma, saturation, intensity, density, lightness, brightness, reflectiveness, colour fidelity or combinations thereof of a hue. It also generally refers to reducing the greyness, whiteness, blackness, hue complement or combinations thereof of a hue. Increasing the colour vibrancy is especially significant when printing on natural-coloured substrates as the darker substrate colour decreases the colour fidelity of the printed image.

In one embodiment of the present invention, the coating comprises from about 5 to about 40% w/w of silica particles, for example, but not limited to about 5, 10, 15, 20, 25, 30, 35 or 40% w/w. In a further embodiment, the coating comprises from about 15 to about 30% w/w of silica particles, for example, but not limited to about 15, 18, 20, 22, 24, 26, 28 or 30% w/w. In yet a further embodiment, the coating comprises about 25% w/w of silica particles. Further, the coating may comprise silica particles in an amount found between any two values listed above.

A person skilled in the art will appreciate that the density of silica particles on the substrate after application of the coating depends on many factors of the coating drying process such as the type of application equipment used, the water content of the coating, the temperature of the substrate, the repellency of the substrate and the size and/or distribution of the silica particle sizes. As used herein, repellency generally encompasses a substrate's capacity to repel water and is discussed in further detail below. The coating may be applied to the substrate when it leaves the press as a hot substrate, for example, a hot paperboard. The coating then dries very quickly, typically starting with the portion most adjacent the surface of the paperboard. This may occur within one second. As the coating dries toward the inside, it seals the paperboard and further penetration of the coating into the paperboard is prevented. It will be understood that a coating with high water content will require a longer drying time, allowing the coating to penetrate or be absorbed by the paperboard resulting in a decreased amount of silica actually deposited onto the surface. In contrast, a coating with a low water content will dry more quickly furnishing a coating with a higher amount of silica since the silica is not absorbed by the paperboard. The temperature of the paperboard also has an effect on the drying process wherein the coating on a high-temperature substrate will cure more quickly, inhibiting or reducing silica particle absorption. Also, a more repellant coating will allow a greater amount of silica particles to remain deposited on the surface. Therefore, a highly absorbent substrate may require an application of a greater amount of silica particles in order to maintain similar surface silica particle density. The resulting density of silica particles may also be modified by modulating the size of the silica particles. Smaller silica particle sizes are more prone to being absorbed by the substrate in comparison to larger particle sizes. The lightness of the colour of the substrate also has an effect on the drying speed. A darker-coloured substrate will require a greater amount of silica to be deposited thereon. Ultimately, the amount of silica applied to the substrate may not reflect the amount of silica that is actually on the surface of the substrate as some silica may be absorbed.

A person skilled in the art will appreciate that the amount of silica applied to the substrate may be tailored to the type of substrate in order to obtain a functioning coating. For example, a substrate possessing relatively high repellency may be coated with 1.8 g silica particles per square meter. It is appreciated that in this process, the coating is to be applied under such conditions as to minimize the penetration of the coating into the substrate, or to control the penetration such that it is at an optimal level, and the densities herein are meant to generally represent the amount of silica particles deposited onto the surface of the substrate. In one embodiment, the coating may be applied to a substrate at a density of from about 0.5 to 10 g silica particles per square meter, for example, but not limited to about 0.5, 1, 1.5, 2, 2.5, 3, 3.5, 4, 4.5, 5, 5.5, 6, 6.5, 7, 7.5, 8, 8.5, 9, 9.5 and 10 g per square meter. In another embodiment, the coating may be applied to a substrate at a density of from about 2 to about 3.5 g silica particles per square meter, for example, but not limited to, about 2, 2.2, 2.5, 2.6, 2.8, 3.0, 3.2 or 3.5 g per square meter. Further, the density of the silica particles may be between any two values listed above.

More than one coating may be applied, for example, a second coating may be applied, to allow for higher coating weights. In this regard, the density of silica particles on the substrate may be increased without modifying the composition of the liquid coating. This can be efficient as the same liquid coating composition may produce different coating weights without increasing the viscosity and difficulty of handling of the liquid coating. It will be appreciated that the coating need not be applied in a consistent density to the substrate and imperfections or fluctuations in density may be present across the substrate.

In one embodiment of the coating, the silica particles:binder solids ratio is from about 10:1 to about 80:1 by weight, for example, but not limited to 10:1, 15:1, 20:1, 25:1, 30:1, 35:1, 40:1, 45:1, 50:1, 55:1, 60:1, 65:1, 70:1, 75:1 or 80:1 by weight. In a further embodiment of the coating, the silica particles:binder solids ratio is from about 35:1 to about 50:1 by weight, for example, but not limited to 35:1, 40:1, 45:1 or 50:1. In yet a further embodiment of the coating, the silica particles:binder solids ratio is about 50:1 by weight. Further, the coating may comprise a silica particles:binder solids ratio as defined by any ratio between any two ratios listed above.

It will be appreciated that the term “binder solids” encompasses a compound or compounds that facilitate or promote the adherence of the silica particles to the substrate. Some examples of binder solids are starches, gums, casein, soy protein, all types of gelatin, starch, sodium or potassium alginate, cellulose derivatives such as hydroxyethylcellulose and carboxymethylcellulose, dextrin, latex, styrene butadiene latex, vinyl polymers (substituted polyvinyl alcohol, polyvinyl acetate, polyvinyl pyrrolidine), styrene polymers (styrene acrylic copolymer), acrylic polymers (acrylonitrile acrylic acid, polymethyl methacrylate, acrylate esters), polyurethanes, polyolefins, polyesters, polycarbonate polymers, epoxy polymers, polyamides, nylons or any other suitable binder solids. These can also be used in mixtures. It will be appreciated that these examples are not limiting in any way and a variety of other binder solids or combinations known in the art may be used in the present invention.

It will be appreciated that the coating may be diluted with water or other suitable diluant to obtain a required or desired concentration of silica particles per square meter of the substrate. Other solutions can also be used to adjust the concentration of silica particles such as alcohols and/or ketones or combinations thereof.

Other components, referred to as additives, may be further added to improve or enhance the performance of the coating. Such additives include pigments that scatter light (kaolin, calcium carbonate, titanium dioxide and talc), plasticizers to improve the flexibility of the coating (stearates and paraffin emulsions), thickeners to control rheological properties (xanthan gum), viscosifiers and water retention agents (natural polymers and cellulose derivatives), preservatives (beta-naphthol formaldehyde), water-resisting agents, bactericides, fungicides, anti-foaming agents (long chain alcohols, surfactants), yellowing inhibitors (sodium hydroxymethanesulfonate, sodium p-toluenesulfinate), antioxidants, wet strengthening agents, dry strengthening agents, dispersants (phosphates, ligno sulphonates, silicates) and ultraviolet light absorbers.

The coating may be applied on a substrate, such as a paperboard. In the context of the present invention, paperboard encompasses all paper-based material, in particular thick paper-based material such as that used to make boxes and sometimes referred to as cardboard. Also encompassed are paper-based materials that are less thick including, for example paper-based materials having a thickness of about 0.1 mm. The paperboard may have a natural colour such as beige, brown or grey and hues between. As used herein, the term “natural colour” or “natural-coloured” encompasses a colour that is not white and falls within the range of colours from beige to brown and grey. One example of a paperboard that has a natural colour is paperboard that is made from post-consumer fibers such as kraft paper used to make boxes, corrugated fiberboards, gift wrap, manila paper, envelopes, paper bags, paper sacks and the like. The post-consumer fibers may be unbleached and have a darker colour. Paperboard may comprise from about 0 to about 100% recycled content.

As outlined herein, percent paper brightness is a measurement of light reflectance and in one embodiment is the measurement of light reflectance of a specific wavelength (457 nm) of blue light. The brightness scale is based on the 100% reflectance of a magnesium oxide standard. Suitable paper products include those that have a brightness of less than about 80% and more than about 20%, for example, but not limited to about 80, 75, 70, 65, 60, 55, 50, 45, 40, 35, 30, 25 or 20%. Further, the paper brightness may be defined by any value between any two values listed above.

In one embodiment, the dye may be a pigmented translucent dye commonly used in lithographic offset printing. A pigmented translucent dye does not completely cover the colour beneath it. These dyes are used to create full colour work, the image arising from the combination of the colours cyan, magenta, yellow and black (CMYB).

In one embodiment, the coating may be applied to a natural-coloured substrate leaving a translucent, matte finish. Upon the application of a dye, the coating allows for an increase in light scattering from the substrate thereby reducing the quantity of light available for absorption by the underlying natural-coloured substrate resulting in significantly improved colour vibrancy of the dye. Unprinted coated substrate areas are unchanged and appear in their original natural colour and matte luster.

In one embodiment, the present invention provides for a coating that increases the colour vibrancy of a dye applied to a substrate comprising a sol aqueous dispersion of a poly dispersement of anionic silica particles having an average particle size of about 1 to 150 nm and wherein the silica particles comprise about 25% w/w of the coating, at least one binder solids, siloxane and wherein the silica particle:binder solids ratio is 15:1 by weight.

In a further embodiment, the present invention also provides a method of increasing the colour vibrancy of a dye on a substrate, the method comprising applying a coating, such as those described herein, to the substrate to yield from about 0.5 to about 10 g or about 2.0 to about 3.5 g of silica particles per square meter of the substrate. The method further comprises drying or curing the coating to cure the binder solids. Drying or curing may be done by heating the substrate or substrate surface.

The coating may be applied to the substrate in any suitable process including those known in the art, such as vapour deposition (chemical vapour deposition and physical vapour deposition), chemical techniques, electrochemical techniques, spraying, size press processes and roller coating processes.

After application of the coating, the coating may be dried or cured in any suitable process including those known in the art, for example heating, air drying, ultraviolet light curing and infra-red curing.

The method may further include the optional step of selecting a substrate. This step involves choosing a substrate that, following application of the coating, results in a treated or coated substrate that is more ideal for providing a surface that, once dye is applied, provides for enhanced or increased vibrancy of the dye. In one embodiment, the substrate may have been previously coated with at least one water repellent coating. A substrate may be analyzed for its repellant properties by any suitable test including those known in the art. One example of such a test is the 3M Water Repellency Test V for Floorcoverings described in U.S. Pat. No. 6,309,752, herein incorporated by reference. In this test, the treated substrate is placed on a flat, horizontal surface. Five small drops of a water/isopropanol mixture are gently placed at points at least two inches apart on the substrate. If, after observing for ten seconds at a 45° angle, four out of the five drops are visible as a sphere or a hemisphere, the substrate is deemed to pass the test. The reported water repellency rating corresponds to the highest isopropanol ratio that was used before the substrate began failing the test. The water repellency ratings is shown in Table 1 below wherein a higher value corresponds to an improved ability to repel water.

TABLE 1

| | Mixture |
|---|---|
| | (water/isopropanol by % by |
| Water Repellency Rating | volume) |
| F | Fails water |
| 0 | 100/0 |
| 1 | 90/10 |
| 2 | 80/20 |
| 3 | 70/30 |
| 4 | 60/40 |
| 5 | 50/50 |
| 6 | 40/60 |
| 7 | 30/70 |
| 8 | 20/80 |
| 9 | 10/90 |
| 10 | 0/100 |

If the substrate tests as not having a repellant coating, a repellant coating may be applied. The repellant coating may be selected from those known in the art and may be applied before applying a coating that allows for increased colour vibrancy of an applied dye.

### EXAMPLES

The following examples are presented to illustrate and demonstrate embodiments of the invention and are not intended to limit the scope thereof.

### Example 1

TABLE 1
60 Degree Percent Gloss

| | | Silica | | | | | |
|---|---|---|---|---|---|---|---|
| | Initial | Particle | | | | | |
| | Substrate | Density | 60 Degree Gloss (%) | | | | |
| | Repellency | (g/m² | | Cyan | Magenta | Yellow | Black |
| Substrate | Rating | silica) | Unprinted | Printed | Printed | Printed | Printed |
| A | 1-2 | 0 | 2.8 | 2.5 | 2.5 | 3.5 | 2.9 |
| B | 1 | 0 | 2.9 | 2.4 | 2.8 | 3.4 | 3.0 |
| C | 1-2 | 0 | 2.8 | 2.4 | 2.5 | 3.3 | 2.7 |
| D | 0 | 0 | 2.4 | 2.4 | 2.2 | 2.9 | 2.0 |
| B1 | 1 | 2.17 | 2.9 | 3.6 | 4.8 | 4.6 | 5.2 |
| C1 | 1-2 | 2.15 | 2.8 | 3.9 | 4.8 | 4.1 | 5.7 |
| D1 | 0 | 4.2 | 2.4 | 4.1 | 4.5 | 4.5 | 4.5 |

Table 1 provides examples of natural-coloured paperboards (substrates A-D, B1, C1 and D1) and the glossiness of the substrates when embodiments of coatings of the present invention and pigmented translucent dyes are applied thereon.

Substrates A-D are uncoated while substrates B1, C1 and D1 correspond to coated substrates B, C and D. The initial substrate repellency rating represents the capacity of the paperboard to repel an aqueous solution. Substrates B and B1 have a repellency rating of 1 and substrates C, C1 and A have a repellency rating of 1-2. A repellency rating of 0 is given to substrate D and D1 indicating high substrate absorbancy.

The coating as used in this example comprises an acrylic polymer binder solid and a silica particles:binder solids ratio of 67:1 by weight. The density of the silica particles in the dried coating on substrates B1 and C1 is approximately 2 g/m². Given the higher absorbency of substrate D1, approximately twice the density (4 g/m²) of silica particles was applied to this substrate.

The percent gloss of the substrates was measured with a glossmeter at 60 degrees (angle between the incident and reflected light) and compared to a black glass standard (100% gloss). A matte finish generally has less than 10% gloss. The glossiness of unprinted coated substrates B1, C1 and D1 was very similar to the glossiness of the corresponding unprinted uncoated substrates B, C and D indicating that the coatings provide a translucent and matte finish. This is particularly advantageous if the application of the coating to the entire area of the paperboard is not desired, for example, when a printed image is to be applied to only one area of the substrate. In this case, the uncoated areas will appear very similar to the coated areas.

The colours (cyan, magenta, yellow and black) in Table 1 refer to the colour of the translucent dyes applied to the substrates via offset printing. The data indicates that the glossiness of the printed-on substrates does not change significantly in the presence of the coating. For example, cyan-printed uncoated substrate B has a gloss value of 2.4%, whereas the gloss value of the cyan-printed coated substrate B1 increased by only 1.2% to a total of 3.6%. On average, the increase in gloss of all the printed-on coated substrates is only 1.8% compared to the printed uncoated substrates. All gloss values are below 10%, indicating that the printed surface remains matte.

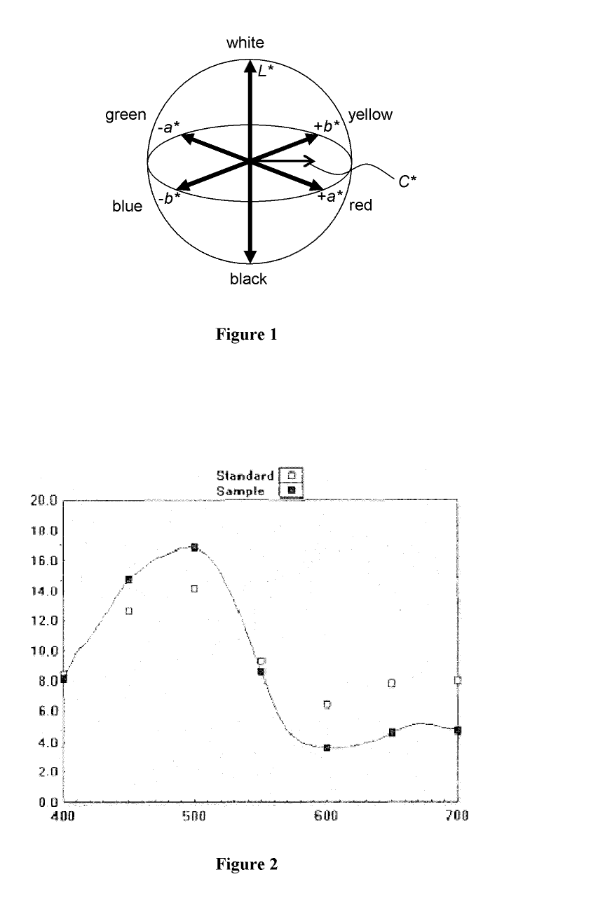

The following examples present CIE L*a*b* (CIELAB) values of printed-on substrates previously shown in Table 1. The three coordinates of CIELAB are shown in the three-dimensional colour space in FIG. 1. L* represents the lightness of the colour, wherein a value of 0 yields black and a value of 100 indicates white. The a* coordinate specifies an amount of red and green, wherein a positive value indicates larger amounts of red and a negative value indicates larger amounts of green. The b* coordinate specifies an amount of yellow and blue, wherein a positive value indicates larger amounts of yellow and a negative value indicates larger amounts of blue. All values were measured under illuminant D50 with 2° observer.

In addition, chroma (a colour's freedom from white or grey) is represented by C* (see FIG. 1). The values range from 0 at the centre of the sphere indicating neutral grey to 100 or more at the edge of the sphere, representing high colour purity lacking greyness. C* takes into consideration a* and b* and is calculated with the following formula:

C*=√[(a*²+b*²)]

In the context of the following examples, AC* indicates the difference in the chroma value between uncoated and coated substrates and is represented by the formula:

ΔC*=C*_{coated substrate}−C*_{uncoated substrate}

### Example 2

TABLE 2
Printed Cyan

Substrate

| CIELAB Value | C | C1 | D | D1 |
|---|---|---|---|---|
| L* | 35.06 | 35.78 | 36.41 | 34.71 |
| a* | −15.10 | −23.75 | −10.78 | −21.12 |
| b* | −16.52 | −20.43 | −9.88 | −18.08 |
| C* | 22.38 | 31.33 | 14.62 | 27.81 |

| | | |
|---|---|---|
| ΔC* | +8.95 | +13.19 |

Table 2 presents uncoated substrates C and D, and corresponding coated substrates C1 and D1 to which a cyan dye was applied. In each case, the a* and b* values for the coated substrate decreased, compared to the uncoated substrate, indicating that the printed hue on the coated substrate is purer (less presence of the complimentary hue). Larger negative values of both a* and b* indicate that the printed colour has larger amounts of green and blue, which are the two colours that yield cyan upon subtractive colour mixing.

More importantly, the chroma values associated with the coated substrates are larger. The fairly substantial ΔC* (approximately +9 for C/C1 and +13 for D/D1) indicates that the printed hue on the coated substrate is less grey and will appear as a more pure and vibrant colour.

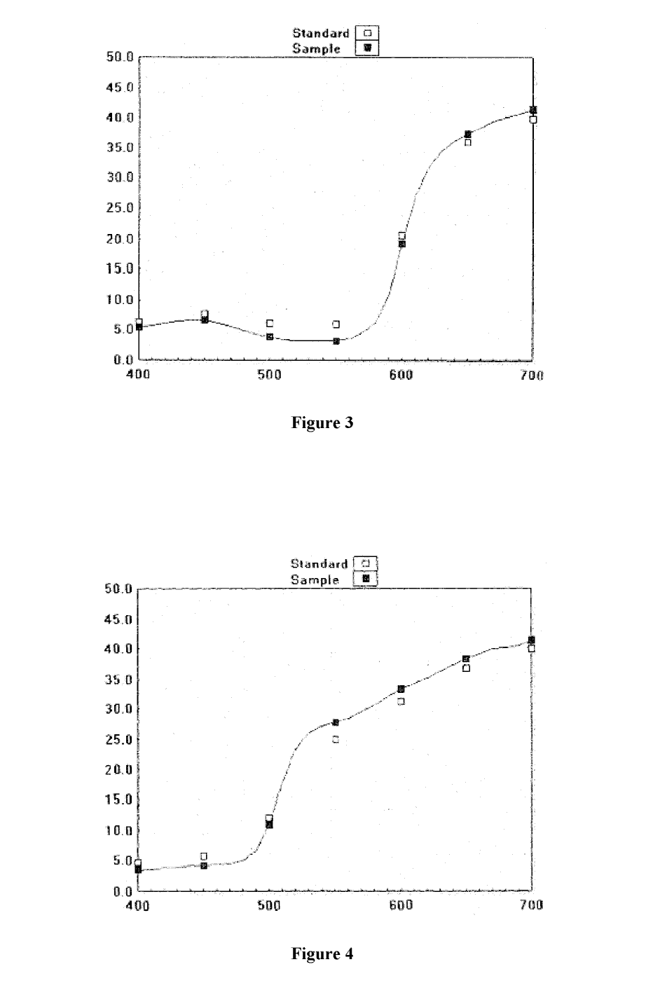

FIG. 2 presents the percent reflectance versus wavelength of an uncoated (standard, white squares) and coated cyan-printed (sample, black squares) substrate. In general, the coated cyan-printed substrate has slightly higher percent reflectance at shorter wavelengths (400-550 nm) and slightly lower percent reflectance at longer wavelengths (550-700 nm) when compared to the uncoated substrate.

### Example 3

TABLE 3
Printed Magenta

Substrate

| CIELAB Value | C | C1 | D | D1 |
|---|---|---|---|---|
| L* | 40.65 | 38.15 | 40.42 | 36.64 |
| a* | 41.01 | 52.27 | 38.02 | 47.45 |
| b* | 15.38 | 14.00 | 13.80 | 13.02 |
| C* | 43.79 | 54.11 | 40.44 | 49.20 |

| | | |
|---|---|---|
| ΔC* | +10.32 | +8.76 |

Table 3 shows the CIELAB values for magenta-printed uncoated and coated substrates. Compared to the uncoated substrates, the coated substrates had higher a* and slightly lower b* values resulting in greater amounts of red and blue (less amount of yellow), corresponding to the hue magenta. Therefore, the coating enables the magenta hue to possess less complimentary hues, yielding a purer magenta. The C* for both coated substrates is greater than the uncoated substrates (ΔC* for C/C1 and D/D1 is approximately +10 and +9, respectively) indicating that a magenta hue printed onto a coated natural-coloured surface will be less grey and have higher colour purity compared to the same applied to an uncoated surface.

With respect to percent reflectance at wavelengths 400 to 700 nm, the values are generally very similar between coated and uncoated substrates (FIG. 3).

### Example 4

TABLE 4
Printed Yellow

Substrate

| CIELAB Value | C | C1 | D | D1 |
|---|---|---|---|---|
| L* | 64.78 | 65.53 | 57.51 | 59.42 |
| a* | 3.97 | 3.09 | 6.84 | 4.90 |
| b* | 45.98 | 61.58 | 45.68 | 55.16 |
| C* | 46.16 | 61.66 | 46.18 | 55.38 |

| | | |
|---|---|---|
| ΔC* | +15.50 | +9.20 |

Table 4 displays the CIELAB values of yellow-printed uncoated and coated substrates. The a* values for the coated substrates are only slightly lower while the b* values are significantly higher. A high b* value is associated with large amounts of yellow. The significantly large ΔC*, especially for substrates C/C1 (+15.5), indicates that the resulting printed yellow hue has less greyness and resembles a purer yellow. This is particularly advantageous as a yellow colour often has low colour fidelity on darker, natural-coloured paperboard.

The yellow-printed coated substrate possesses a nearly identical profile of percent reflectance as the yellow-printed uncoated substrate (FIG. 4).

### Example 5

TABLE 5
Printed Black

Substrate

| CIELAB Value | C | C1 | D | D1 |
|---|---|---|---|---|
| L* | 25.85 | 18.94 | 30.54 | 22.2 |
| a* | 1.19 | 0.65 | 2.54 | 1.39 |
| b* | 2.58 | 1.55 | 4.73 | 1.82 |
| C* | 2.85 | 1.69 | 5.37 | 1.95 |

| | | |
|---|---|---|
| ΔC* | −1.16 | −3.42 |

The CIELAB values of uncoated and coated substrates to which black dye has been applied are presented in Table 5. All a* and b* values corresponding to the coated substrates are lower compared to the uncoated substrates indicating that each hue is diluted with the complementary hue, resulting in an increase in greyness. In comparison, Examples 2-4 above, C* values for the present Example are lower for the coated substrates yielding a negative ΔC*. Most significantly is the decrease in L* for the coated substrates. In comparison to the other colours (cyan, magenta and yellow), the vibrancy of the black is increased by reducing the chroma and lightness. Therefore, the coatings of this example enable the printed black to be darker and more vibrant.

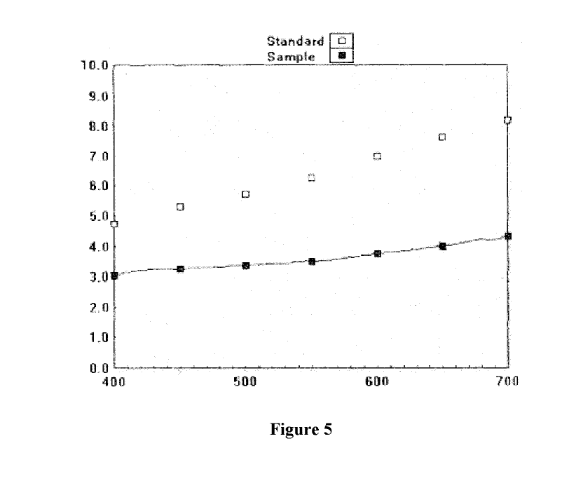

FIG. 5 indicates that the percent reflectance of the black-printed coated substrate (sample, black squares) is lower than the reflectance of the uncoated substrate (standard, white squares), confirming that the deeper black colour is due to the greater absorbance of light by the substrate.

Various embodiments of coatings, methods, and coated substrates have been described for increasing the colour vibrancy of dyes applied to a treated or coated substrate. The above-described embodiments are intended to be examples and alterations and modifications may be effected thereto, by those of ordinary skill in the art, without departing from the scope of the teachings.

What is claimed is:

1. A translucent coating for a substrate, the coating comprising silica particles and one or more binder solids.

2. The coating of claim 1, wherein the silica particles are substantially spherical particles of anionic amorphous silica.

3. The coating of claim 1, wherein the silica particles are in an aqueous sol dispersion.

4. The coating of claim 1, wherein the coating comprises a mono or a poly dispersement of the silica particles.

5. The coating of claim 4, wherein the average particle size of the silica particles in the mono dispersement is selected from the group consisting of about 1 to about 150 nm, about 12 to about 40 nm and about 16 to about 18 nm.

6. The coating of claim 4, wherein the coating comprising the poly dispersement further comprises siloxane.

7. The coating of claim 4, wherein the silica particles in the poly dispersement have a particle size of from about 1 to about 150 nm.

8. The coating of claim 1, wherein the weight of the silica particles in the coating is selected from the group consisting of about 5 to about 40% w/w, 15 to about 30% w/w and 25% w/w.

9. The coating of claim 1, wherein the coating is for application to the substrate at a density selected from the group consisting of about 0.5 to about 10 g silica particles per square meter and about 2.0 to about 3.5 g silica particles per square meter.

10. The coating of claim 1, wherein the coating is applied more than once on the substrate.

11. The coating of claim 1, wherein the silica particles:the at least one binder solids ratio is selected from the group consisting of about 10:1 to about 80:1 by weight, about 35:1 to about 50:1 by weight and 50:1 by weight.

12. The coating of claim 1, wherein the coating is suitable for an application of a pigmented translucent dye thereon.

13. The coating of claim 1, wherein the coating has a translucent and matte finish.

14. The coating of claim 1, wherein the substrate is a paperboard with a natural colour comprising from about 0 to about 100% recycled content.

15. The coating of claim 1, wherein the substrate has a brightness of from about 5 to about 80.

16. A coating for increasing the colour vibrancy of a dye applied to a substrate comprising:
a sol aqueous dispersion of anionic silica particles having a range of sizes from about 1 to about 150 nm;
at least one binder solids;
siloxane;
wherein the silica particles comprise about 25% w/w of the coating; and
the silica particle:the at least one binder solids ratio is 50:1 by weight.

17. A method of increasing the colour vibrancy of a dye applied to a substrate, the method comprising:
a) applying a coating as defined by claim 1 in an amount of from about 0.5 to about 10 g of silica particles per square meter of the substrate; and
b) drying or curing the binder solids.

18. The method of claim 17, wherein step b) comprises applying heat to dry or cure the binder solids.

19. The method of claim 17, further comprising a preliminary step of selecting the substrate based on the repellency of the substrate.

20. The method of claim 17, wherein the substrate is pretreated with a repellent coating.
